(19) United States
(12) Patent Application Publication
(10) Pub. No.: US 2004/0004942 A1
(43) Pub. Date: Jan. 8, 2004

(54) Multi-media communication management system having graphical user interface conference session management

(75) Inventors: Robert M. Nebiker, Naples, FL (US); Robert F. Meyerson, Naples, FL (US)

Correspondence Address: TIMOTHY P. O'HAGAN, 8710 KILKENNY CT, FORT MYERS, FL, 33912, US

(73) Assignee: Teleware, Inc., Akron, OH

(21) Appl. No.: 10/620,984

(22) Filed: Jul. 16, 2003

Related U.S. Application Data
(63) Continuation-in-part of application No. 09/961,532, filed on Sep. 24, 2001.
(63) Continuation-in-part of application No. 10/000,543, filed on Oct. 23, 2001.
(63) Continuation-in-part of application No. 10/081,513, filed on Feb. 21, 2002.

(51) Int. Cl. H04N 7/14; H04Q 11/00; H04L 12/16

(52) U.S. Cl. 370/260; 348/14.08

(57) ABSTRACT

The multi-media communication management system comprises a controller that interfaces with a plurality of subscriber stations and with one or more communication medium service providers. The controller provides video conference services to the subscriber stations. To provide video conference services, the controller receives an indication of a plurality of conference session participants. The controller identifies a participating subscriber station that is serving a subscriber device associated with each conference session participant. A conference mix module establishes a streaming media communication channel with each participating subscriber station for receiving an audio signal from the participating subscriber station and for sending a mixed audio signal to the participating subscriber station.

### CROSS REFERENCE TO RELATED APPLICATIONS

The present application is a continuation in part of U.S. patent application Ser. No. 09/961,532 titled Teledata Space and Docking Station with Modular and Integrated Display filed on Sep. 24, 2001, and is a continuation in part of U.S. patent application Ser. No. 10/000,543 filed on Oct. 23, 2001, titled Modular Multi-Media Communication Management System, and is a continuation in part of U.S. patent application Ser. No. 10/081,513 filed on Feb. 22, 2002, titled Multi-Media Communication Management System with Enhanced Video Conference Services, the contents of all such patent applications is incorporated herein.

### TECHNICAL FIELD

The present invention relates generally to managing multi-media communications, and more particularly to a modular system for managing video conference communications.

### BACKGROUND OF THE INVENTION

Multi party calls or conference calls have provided a convenient method for enabling remotely located individuals to orally participate in a meeting. Many existing PBX systems enable the operator of a desk top telephone to place calls to multiple parties and conference the multiple parties together. The PBX establishes a circuit switched connection with each participant (whether on the public switched telephone network (PSTN) or the private network controlled by the PBX) and then bridges the lines together.

One problem associated with such a system is that the operator of the desk top phone must initiate the conference call by dialing each participant and using an appropriate conference button(s) and/or a hold button(s) to bring all participants together. Such a process is time consuming at best. And, if an operator is not familiar with the telephone system, such a process may require reliance on a manual to properly activate the correct button sequences to dial each participant to initiate the call.

Another problem associated with such systems is that audio quality degrades when participants are added. The voice volume of each participant may be unequal and background noise from each line is aggregated into the conference. Typically audio quality becomes unacceptable when greater than three participants are connected.

More recently conferencing bridge systems have been developed to improve conference call quality. Typically each participant will dial into a conferencing bridge and enter a pass code to join a conference. The conferencing bridge includes signal processing circuits for reducing background noise, echo cancellation, and balancing the volume of different speakers.

A problem with conferencing bridge systems is that the conference call must be scheduled with the bridge and each caller must call into the bridge. Therefore, if the operator of a desk top telephone desires to set up a conference call with four participants, the operator must first schedule a call with the bridge and set a pass code for participants to use when calling into the bridge. Secondly, the operator must notify each participant of the dial-in number to the bridge and the pass code to enter the conference. This is at least as cumbersome as dialing all four participants and utilizing the PBX for the conference.

Another problem associated with both the PBX system and the bridge system is that there exists no convenient system for monitoring participation in the conference call. At best, a participant could manually track entries and departures based on the system notifications typically provided by the bridge system using a synthesized voice. Such manual tracking is distracting and subject to error.

Yet another problem associated with the known conferencing systems is that they do not provide a system for two or more remote participants to converse in private such that they can hear each other but can not be heard by the other participants.

What is needed is a multi media communication management system that provides audio and video conferencing services that does not suffer the disadvantages of the existing communication systems.

### SUMMARY OF THE INVENTION

The multi-media communication management system comprises a control unit that facilitates a communication conference between a plurality of real time communication devices. The control unit comprises a local network interface for exchanging local network data over a packet switched network with each of the plurality of real time communication devices.

The control unit may further include an address book file storing address book content (identifying each of a plurality of contacts) and means for providing the address book content to one of the communication devices in response to the communication device providing an indication of a request to establish a conference session.

The control unit may comprise means for receiving an identification of selected contacts from the communication device, such selected contacts being conference participants.

The control unit further comprises means for establishing a plurality of real time audio conference channels. Each channel is between the control unit and a conference participant and each channel provides for receiving streaming audio data from the participant and provides for sending conference mix streaming audio to the participant. More specifically, the means for establishing a plurality of real time audio conference channels may comprise means for providing session signaling to each participant and means for negotiating the set up of a real time audio channel with the participant in response to the participant responding to the session signaling.

The means for establishing a real time communication channel with each of the plurality of conference participants may further provide for receiving motion video data from at least one conference participant and providing motion video data to at least a second conference participant. The video may be provided in a video display document comprising a frame for display of the motion video data.

A second aspect of the present invention is to provide a method for facilitating a conference between a plurality of real time communication devices. The method comprises: i) communicating with each real time communication device over a packet switched network; ii) receiving an identification of each of a plurality of real time communication devices selected as conference participants; iii) establishing a plurality of real time audio conference channels, and iv) generating conference mix streaming audio data from streaming audio data received from at least two participants.

Each real time audio conference channel is between the control unit and a conference participant. It provides for receiving streaming audio data from the conference participant and providing a conference mix streaming audio data to the participant.

The step of establishing a plurality of real time audio channels may comprise: i) providing session signaling to each session participant; and ii) negotiating set up of a real time audio channel with a conference participant in response to the conference participant responding to the session signaling.

The method may further comprise: i) obtaining address book content from an address book file, the address book content comprising an identification of each of a plurality of contacts; and ii) providing the address book content to one of the real time communication devices in response to the real time communication device providing an indication of a request to establish a communication conference. As such, the step of receiving an identification of each of a plurality of real time communication devices selected as conference participants may comprise receiving an indication of subscriber selection of contacts from the address book content.

The step of establishing a plurality of real time audio conference channels may further comprise: establishing a real time communication channel with at least one conference participant for receiving motion video data from the at least one conference participant and providing motion video data to at least a second conference participant.

For a better understanding of the present invention, together with other and further aspects thereof, reference is made to the following description, taken in conjunction with the accompanying drawings, and its scope will be pointed out in the appended clams.

### BRIEF DESCRIPTION OF THE DRAWINGS

FIG. 1 is a block diagram representing a multi-media communication management system in accordance with one embodiment of the present invention;

FIG. 2 is a block diagram representing an exemplary subscriber telephony station;

FIG. 3 is a block diagram representing an exemplary wireless telephony device;

FIG. 4 is a block diagram representing an exemplary personal data device;

FIG. 5 is a block diagram representing a second exemplary personal data device;

FIG. 6 is a block diagram representing an exemplary control unit;

FIG. 7 is represents an exemplary routing table;

FIG. 8 is a flow chart representing exemplary operation of a session initiation proxy server;

FIG. 9 is a block diagram representing an exemplary conference server;

FIG. 10 is a flow chart representing exemplary operation of a conference server application;

FIG. 11a represents an exemplary conference initiation document;

FIG. 11b represents an exemplary session status document;

FIG. 12a represents an exemplary single frame video display document;

FIG. 12b represents an exemplary multi frame video display document;

FIG. 13 represents an exemplary session status table;

FIGS. 14a, 14b, and 14c are each flow charts that represent operation of a web server management application in accordance with one embodiment of the present invention;

FIG. 15 represents an exemplary main menu display document;

FIGS. 16a and 16b are each flow charts that represent exemplary operation of an email module;

FIG. 17 is a flow chart representing exemplary operation of a multicast application in accordance with one embodiment of the present invention; and

FIG. 18 represents an exemplary paging initiation document.

### DESCRIPTION OF THE PREFERRED EMBODIMENTS

The present invention is now described in detail with reference to the drawings. In the drawings, each element with a reference number is similar to other elements with the same reference number independent of any letter designation following the reference number.

It should also be appreciated that many of the elements discussed in this specification may be implemented in hardware circuit(s), a processor executing software code, or a combination of a hardware circuit and a processor executing code. As such, the term circuit or module as used throughout this specification is intended to encompass a hardware circuit (whether discrete elements or an integrated circuit block), a processor executing code, or a combination of a hardware circuit and a processor executing code, or other combinations of the above known to those skilled in the art.

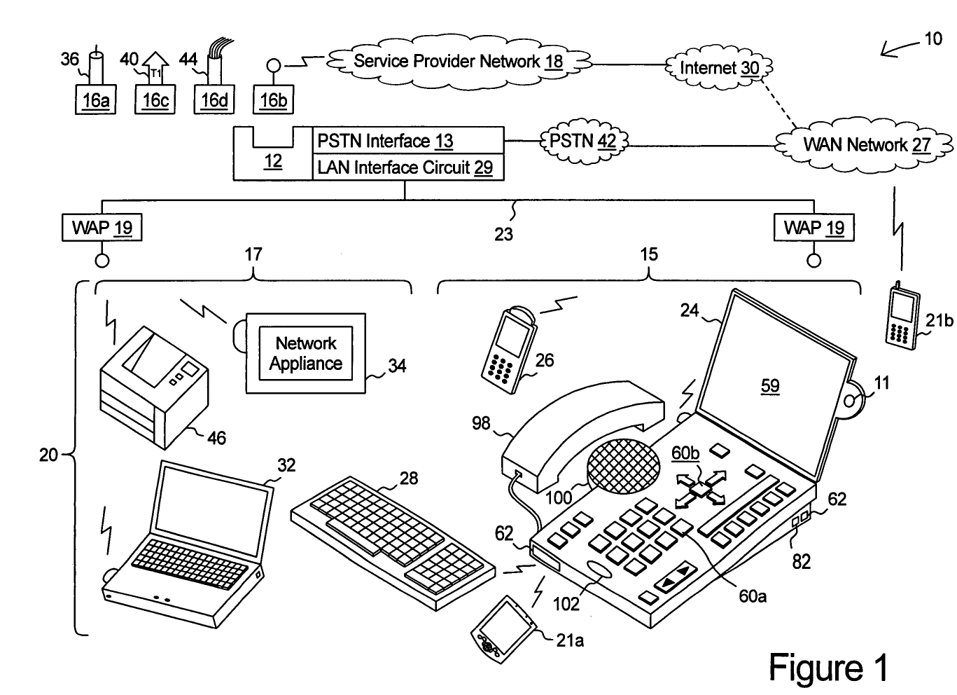

FIG. 1, is a diagram representing an architecture of a multi-media communication management system 10 of the present invention. The system 10 is coupled to both of a multi-media service provider network 18 and the public switched telephone network (PSTN) 42.

The service provider network 18 may be TCP/IP compliant and utilize a combination of one or more of co-axial cable, fiber optic cable, T1 lines, and wireless RF channels as its physical communication medium. The service provider network 18 may couple to the Internet 30 through appropriate gateways and/or routers to enable system 10 to communicate with TCP/IP compliant devices coupled to the service provider network 18 or the Internet 30 (collectively, remote TCP/IP compliant devices).

Both the PSTN 42 and the Internet 30 may include appropriate gateways coupled to a wide area wireless network 27 which may be a cellular telephone or PCS telephone network to enable system 10 to communicate with remote wireless devices operating within the network 27.

The system 10 includes a control unit 12, a plurality of network devices 20, a plurality of personal data devices 21, and a wireless local area network 22 that interconnects the network devices 20 to each other and to the control unit 12.

The wireless local area network 22 may be a TCP/IP compliant packet switched network and utilize a combination of a wired backbone network 23 (such as an Ethernet Network) and micro-cellular RF cells as its physical communication medium. Each micro-cellular RF cell may be an 802.11 compliant wireless cell controlled by an access point 19 that is uplink coupled to the backbone network 23 or wirelessly uplink coupled to another access point 19.

The control unit 12 includes a LAN interface circuit 29 for coupling to the local area network 22 and enabling communication with network devices 20, a PSTN interface circuit 13 for coupling to the PSTN 42 (e.g coupling to multiple telephone lines from a telephone service provider central office) and enabling communication with remote PSTN devices coupled to the PSTN 42, and a modular service provider interface 16 for coupling to the service provider network 18 and enabling communication with remote TCP/IP compliant devices.

The network devices 20 may include data devices 17 such as traditional computer systems 32, network printers 46, various network appliances 34 and real time communication devices 15 such as subscriber telephony stations 24 and wirelessly telephony devices 26.

Each personal data device (PDA) 21 may be similar to a commercially available device known as a Personal Data Assistant (PDA) and may include a point-to-point communication system 62 for communication with a corresponding point-to-point communication system 62 within a station 24. Further, PDA 21a may include a wide area wireless communication module for communication with other devices over the cellular or PCS wide area network 27. PDA 21a may be similar to a commercially available cellular or PCS telephone that includes PDA capabilities.

Subscriber Stations

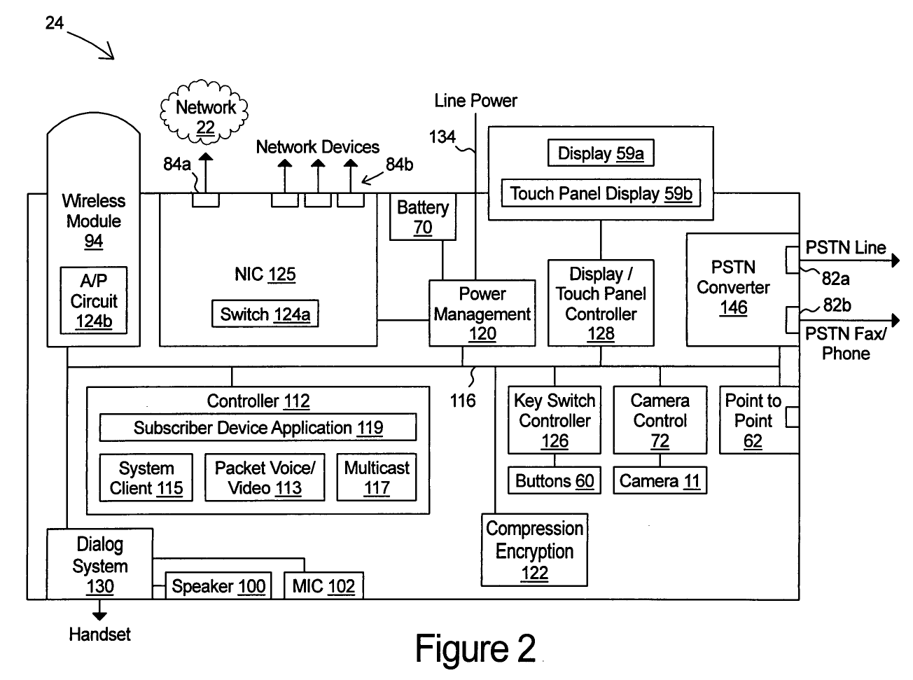

Referring to the block diagram of FIG. 2 in conjunction with FIG. 1, exemplary structure of the telephony station 24 is shown. The station 24 may include a controller 112 coupled to a local bus 116 that interconnects the controller 112 with a plurality of peripheral circuits. The peripheral circuits may include a wireless module 94, a network interface circuit (NIC) 125, a power management controller 120, compression/encryption hardware (CODEC) 122, a key switch controller 126, a display/touch panel controller 128, a camera controller 72, a PSTN converter 146, a dialog system 130, and at least one point-to-point wireless communication module 62.

Further, coupled to such peripheral circuits, the station 24 may include: i) a handset 98 similar to a traditional telephone handset coupled to the dialog system 130 to provide a subscriber audio interface and/or a speaker 100 and a microphone 102 coupled to the dialog system 130 to provide a hands-free subscriber “speakerphone” interface; ii) a modular battery pack 70 coupled to the power management controller 120 for operating power when the subscriber station 24 is uncoupled from a line power source; iii) a display screen 59a or a touch panel display screen 59b coupled to the display/touch panel controller 128 for display of information to the subscriber; iv) a digital camera 11 coupled to the camera controller 72 for still image or motion video input; and v) a plurality of buttons 60 coupled to the key switch controller 126 for subscriber key input. The buttons may include twelve buttons (10 numerals, * and #) configured as a telephone key pad 60a and other buttons configured as a menu navigation and menu selection key pad 60b.

Both the wireless module 94 and the NIC 125 couple to the bus 116 (either directly or through an interface circuit such as a PCMCIA controller), operate under control of applicable drivers operated by the controller 112, and enable the station 24 to communicate with other devices over the network 22.

The wireless module 94 provides such coupling via a wireless link to an access point 19 while the network interface circuit 125 provides such coupling by a direct connection to the backbone network 23 via an uplink port 84a. Exemplary wireless modules 94 may include commercially available wireless network interface cards that wirelessly communicate with an access point 19 utilizing an IEEE 802.11 protocol. Exemplary network interface circuits 125 may include commercially available network interface cards that communicate with a network hub or switch using an Ethernet protocol.

The NIC 125 may include switch circuitry 124a that enables the station 24 to operate as a network switch between the uplink port 84a and multiple down link ports 84b. Similarly, the wireless module 94 may include access point circuitry 124b which enables the wireless module 94 to operate as a wireless access point managing wireless communication within its own micro-cell and operate as a switch between uplink communications with an access point 19 (on the channel established by the access point 19) and downlink communications within the micro-cell on a channel established by and controlled by the wireless module 94.

Further, both the wireless module 94 and the NIC 125 may include applicable circuits for communicating frames with each other such that: i) uplink communication utilizes wireless module 94 while downlink communication utilizes the NIC 125; or ii) uplink communication utilizes the NIC 125 while downlink communication utilizes the wireless module 94.

The power management controller 120 selectively receives input power from the battery 70, external power source 134, and/or the backbone network 23 via the network interface circuit 125. The power management controller 120 includes appropriate circuits for converting the input power to appropriate operating power required by each component of the station 24. Additionally, the power management controller 120 includes appropriate circuits for managing charging of the battery 70 when power is available from the external power source 134 or the backbone network 23.

The wireless point-to-point communication module 62 couples to the bus 116 (either directly or through an interface circuit such as a serial communication controller), operates under control of applicable drivers operated by the controller 112, and enables synchronization of data between the station 24 and the PDA 21 and enables operation of the keyboard 28 (both the PDA 21 and the keyboard 28 include a corresponding wireless point-to-point communication module 62).

Exemplary point-to-point communication modules 62 include known modules that couple to a bus 116 through a serial communication circuit and utilize the IRDA standard or the Blue-Tooth standard for wireless data transfer.

The display/touch panel controller 128 couples to the bus 116, operates under control of applicable drivers operated by the controller 112, and enables the display 59a (or the touch panel display 59b) to provide information to the subscriber (and receive subscriber input through the touch panel display 59b). In the exemplary embodiment, the display/touch panel controllers 128 may include a separate display control circuit compatible with the resolution and color depth of the display 59a or 59b and a touch panel control circuit for detecting subscriber contact with the touch panel 59b.

The key switch controller 126 couples to the bus 116, operates under control of applicable drivers operated by the controller 112, and enables the controller 112 to receive subscriber input through the buttons 60.

The PSTN converter 146 couples to the bus 116, operates under control of applicable drivers operated by the controller 112, and provides an FXS port 82a for coupling to a PSTN line and/or an FXO port 82b for supporting operation of a traditional telephone or fax machine.

The CODEC 122 couples to the bus 116, operates under control of applicable drivers and a packet voice video application 113 operated by the controller 112. The CODEC 122 includes hardware circuits with adequate operating speed to: i) compress (and optionally encrypt) digital audio provided by the dialog system 130 and digital video provided by the camera controller 72 into sequences of RTP frames for sending to another VOIP endpoint during a media session; and ii) sequence, decompress (and optionally decrypt) RTP frames provided by the other VOIP endpoint into digital audio for presentation to the dialog system 130 and into digital video for display on the display 59.

The camera controller 72 couples to the bus 116, operates under control of applicable drivers operated by the controller 112, and generates digital still image or motion video signals for presentation to the compression encryption module 112 for transmission to another endpoint during a VOIP media session and/or for presentation to another applicable application operated by the controller 112 for display on the display 59.

The dialog system 130 couples to the bus 116, operates under control of applicable drivers operated by the controller 112, and includes applicable circuits for: i) driving the speaker 100 (or the speaker in the handset 98) in accordance with digital audio received from the CODEC 122 and ii) detecting input from the microphone 102 (or the microphone in the handset 98) and generating digital audio for presentation of the CODEC 122.

The controller 112 may operate the above discussed drivers, the packet audio/video communication client 113, a system client application 115, a subscriber device application 119, and a multicast application 117.

The communication client 113 operates as a voice-over-internet-protocol VOIP compliant endpoint (VOIP endpoint) to enable the station 24 to provide real time communication services by establishing and maintaining VOIP media sessions with other VOIP endpoints. In the exemplary embodiment, the client 113 may be one of the commercially available clients utilizing established protocols such as the Internet Engineering Task Force (IETF) Session Initiation Protocols, or other protocols useful for signaling, establishing, maintaining, and tearing down VOIP media sessions utilizing UDP/IP channels over the IP compliant networks. More specifically, the client 113 may generate and respond to SIP compliant Invite, Ringing, OK, ACK, BYE, Cancel, and other SIP compliant messages known in the art.

The system client application 115 enables the station 24 to function as a client to web server applications. An exemplary client application 115 may be a known web browser that provides for: a) initiating a TCP/IP connection to a web server application; b) generating an image on the display 59 in accordance with a display document or display content and a style sheet received from a web server; c) output of digital audio representing an audio stream file to the dialog system 130; and d) execution of processing steps in accordance with script instructions received from a web server. Such processing steps may include providing messages or posts to the web server indicating subscriber actions (such as keyboard entry, keypad entry, or touch panel entry) and may also include providing an instruction to the communication client 113 to set up a media session in accordance with an identifier provided by the client application 115.

The multi cast module 117 may be a commercially available multicast client compatible with the IP Multicast standard and provides for the station 24 to receive invitations to multicast groups, join multicast groups, and couple received multicast media to the dialog system 130 or the display 59 for output.

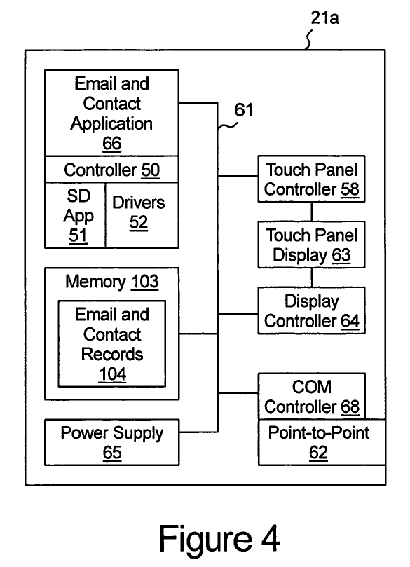

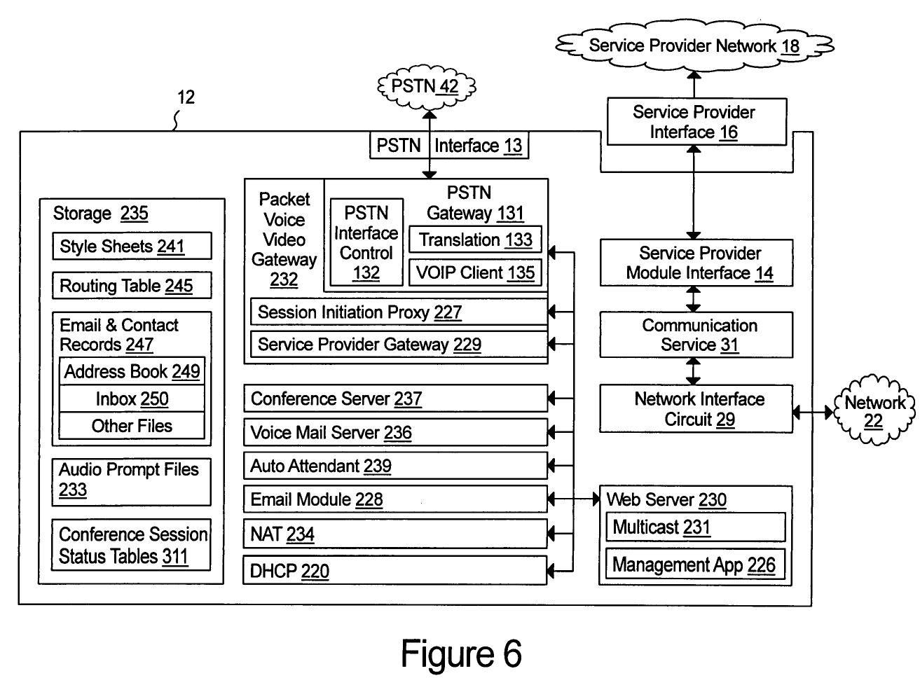

The subscriber device application 119 provides application layer coupling to a corresponding application 51 in each PDA 21 (FIG. 4) for synchronization of email and contact records 104 in the PDA 21 with email and contact records 247 (FIG. 6).

Wireless Telephony Device

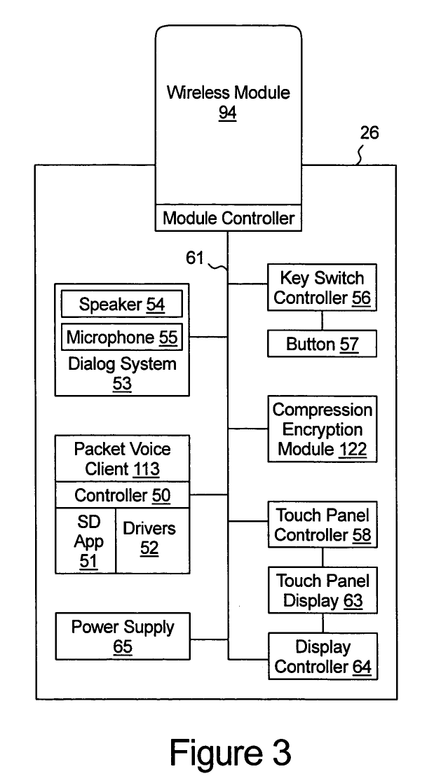

Turning to FIG. 3 in conjunction with FIG. 1, exemplary structure of the wireless telephony device 26 is shown. The device 26 comprises a controller 50 coupled to a local bus 61 that interconnects the controller 50 with a plurality of peripheral circuits. The peripheral circuits may include a wireless module 94, a dialog system 53, a CODEC 122, a key switch controller 56, a touch panel controller 58, a display controller 64, and a power supply 65. Further, coupled to the peripheral circuits, the device 26 may comprises a speaker 54 and a microphone 55 coupled to the dialog system 53 to provide a subscriber audio interface, buttons 57 configured as a telephone keypad and coupled to the key switch controller to provide subscriber key input, and a touch panel display 63 coupled to each of the display controller 64 and the touch panel controller 58 to provide a graphic subscriber interface.

The wireless module 94 may couple to the bus 61 either directly or through an interface circuit such as a PCMCIA controller, operate under control of applicable drivers operated by the controller 50, and, as discussed with reference to the station 24, enable the device 26 to communicate with other devices over the network 22.

The CODEC 122 may couple to the bus 61, operate under control of applicable drivers and a packet voice client application 113 operated by the controller 50. As discussed with reference to the station 24, the CODEC 122 includes hardware circuits with adequate operating speed to: i) compress (and optionally encrypt) digital audio provided by the dialog system 53 into sequences of RTP frames for sending to another VOIP endpoint during a media session; and ii) sequence, decompress (and optionally decrypt) RTP frames provided by the other VOIP endpoint into digital audio for presentation to the dialog system 53.

The power supply 65 includes a battery and power supply circuitry. The power supply circuitry selectively receives input power from the battery and an external power source and converts the input power to appropriate operating power required by each component of the device 26.

The dialog system 53 couples to the bus 61, operates under control of applicable drivers operated by the controller 50, and includes applicable circuits for: i) driving the speaker 54 in accordance with digital audio received from the compression encryption module 122, and ii) detecting input form the microphone 55 and generating digital audio for presentation to the compression encryption module 122.

The display controller 64 and the touch panel controller 58 each couple to the bus 61, operate under control of applicable drivers operated by the controller 50, and together enable the touch panel display 63 to provide information to the subscriber and receive subscriber input. In the exemplary embodiment, the display controller 64 and the touch panel controllers 58 are each compatible with the display resolution and the touch panel resolution of the touch panel display 63,

The key switch controller 56 couples to the bus 61, operates under control of applicable drivers operated by the controller 50, and enables the controller 50 to receive subscriber input through the buttons 57.

The packet voice communication client 113 is operated by the controller 50 and, as discussed with reference to the station 24, operates to establish and maintain VOIP media sessions with other VOIP endpoints over the network 22.

PDA

Referring to FIG. 4, exemplary structure of the PDA 21a is shown. The PDA 21a includes all of the same structures as the wireless telephony device 26 discussed with reference to FIG. 3, but may not include the packet voice communication client 113, the wireless module 94, the key switch controller 56, the buttons 57, or the dialog system 53, speaker 54, and microphone 55.

In addition to the elements discussed with reference to the telephony device 26, the PDA 21a include a wireless point-to-point communication module 62, a subscriber device application 51, an email and contact application 66, and email and contact records 104 stored in a memory 103.

The wireless point-to-point communication module 62 couples to the bus 61 (either directly or through an interface circuit such as a serial communication controller), operates under control of applicable drivers operated by the controller 50, and enables communication with a corresponding module 62 in a station 24.

The subscriber device application 51 is operated by the controller 50 and is similar to, and compatible with, the subscriber device application 119 of the station 24. The application 51 provides for synchronization (through the station 24) of email and contact records 104 with email and contact records 247 in the control unit 12.

The email and contact application 66 is operated by the controller 50 and provides for displaying information from the email and contact records 104 on the touch panel display 63 and for enabling subscriber manipulation of such records via the touch panel display 63 or the buttons 57. The email and contact application 66 may be any commercially available email and contact client that is configured for operation on a small size display screen.

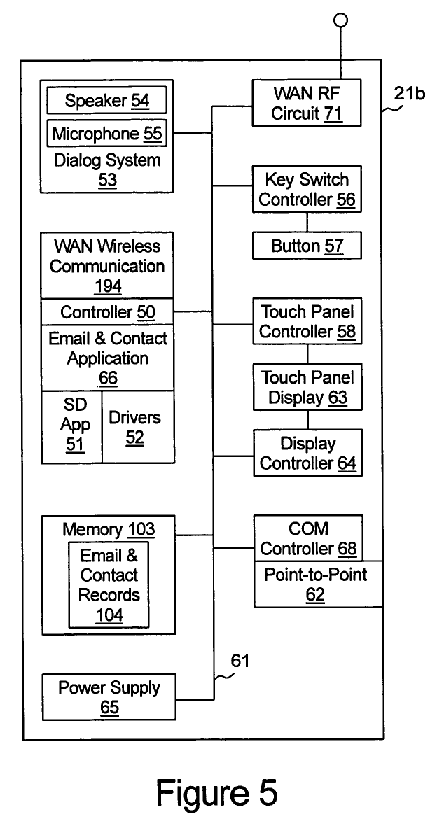

FIG. 5 represents exemplary structure of a PDA 21b. The personal data device 21b includes all of the same structures as the PDA 21a discussed with reference to FIG. 4, and may further include the dialog system 53, speaker 54, microphone 55, key switch controller 56 and buttons 57 discussed with reference to the wireless telephony device 26 and may further yet include a wide area wireless RF circuit 71 and a wireless communication application 194.

The wide area network RF circuit 71 may be a circuit for transmitting and receiving signals over the wide area network service provider's network 27 under control of the wireless communication application 194. The wireless communication application 194 may operate the circuit 71 in accordance with the protocols for communication on the network 27, provide audio data received via the network 27 to the dialog system 53 for output through the speaker 54, and receive a signal representing microphone 55 input from the dialog system 53, and transmit a representation thereof on network 27.

Control Unit

Referring to FIG. 6 in conjunction with FIG. 1 an exemplary control unit 12 is shown. The control unit 12 includes a service provider module interface 14 for coupling to the service provider interface 16, the PSTN interface 13, the local area network circuit 29, a packet audio/video gateway 232 (comprising a PSTN gateway 131, a session initiation proxy server 227, and a service provider gateway 229), a conference server 237, a voice mail server 236, an auto attendant module 239, an email module 228, a network address translation server 334, an address server 220, a web server 230, storage 235, and communication services 31.

Some illustrative examples of a service provider interface 16 include: i) cable modem module 16a for communicating over coaxial cable 36 with a coaxial cable based service provider network 18, ii) wireless radio module 16b for communicating over a wireless communication channel 38 with a service provider access point of a satellite or terrestrial wireless based service provider network 18; iii) a customer service unit (CSU) 16c for communication over a T1 line 40 with a digital PSTN based service provider network 18; and a fiber optic 16d for communication over a fiber optic based service provider network 18.

The PSTN interface 13 couples to the one or more telephone lines from the central office of the PSTN 42 and couples to the PSTN gateway 131. The PSTN interface 13 comprises applicable circuits for interfacing with the telephone line under control of the PSTN gateway 131 including, but not limited to, circuits for: i) taking the telephone line off hook to initiate a PSTN telephone call or to respond to PSTN ringing provided by the central office; ii) detecting dial tone on the telephone line and providing a digital representation of the dial tone to the PSTN gateway 131; iii) modulating DTMF tones onto the telephone line in accordance with a digital audio representation of the tones (or other applicable instructions) provided by the PSTN gateway 131; iv) modulating audio (analog or PSTN digital audio) onto the telephone line in accordance with a digital representation of audio provided by the PSTN gateway 132; and v) detecting modulated audio (analog or PSTN digital audio) on the telephone line and providing a digital representation thereof to the PSTN gateway 131.

Each of the PSTN gateway 131, the session initiation proxy server 227, the service provider gateway 229, the conference server 237, the voice mail server 236, the auto attendant module 239, the email module 228, the network address translation server 234, the address server 220, and the web server 230 exchange information with each other and with remote applications operating on remote devices coupled to the network 22 or the service provider network 18 utilizing TCP/IP connections and UDP/IP channels. As such, communication services 31 comprise applicable IP stacks and port management systems for enabling such communication between components and provides for interfacing between the components and each of a network interface circuit 29 and the service provider module interface 14 for setting up TCP/IP connections and UDP/IP channels over the network 22 and the service provider network 18 respectively.

The address server 220 and the translation server 234 enable the control unit 12 to operate the network 22 as an IP subnet. The address server may be a known DHCP server that operates to assign IP addresses to the network devices 20. The translation server 234 may be a known IP layer proxy (e.g. NAT Server) enabling the various devices 20 to establish TCP/IP connections and UDP/IP channels to devices coupled to the service provider network 18.

A media session between two VOIP endpoints may be a VOIP session directly between the two VOIP endpoints. A media session between a VOIP endpoint and a circuit switched device coupled to the PSTN 42 may comprise a VOIP session between the VOIP endpoint and the PSTN gateway 131 plus a PSTN session between the PSTN interface 13 and the circuit switched device.

As such, the PSTN gateway 131 comprises: i) PSTN interface control circuits 132 which enable the PSTN gateway 131 to control the PSTN interface 13 to operate as a PSTN endpoint to a PSTN session with a remote circuit switched device over the PSTN 42, ii) a VOIP client circuit 135 that enables the PSTN gateway 131 to operate as a VOIP endpoint to a VOIP session with a corresponding VOIP client (either another device on network 22, the conference server 237, the voice mail server 236, or the auto attendant 239), and iii) a translation circuit 133 (including a CODEC 122) that translates audio between the PSTN session and the VOIP session.

The service provider gateway 229 operates as an IP layer proxy for translating frames between a VOIP endpoint on the network 22 and a VOIP endpoint on the service provider network 18 or the Internet 30.

The session initiation proxy server 227 facilitates set up of a VOIP session between two VOIP endpoints by routing session signaling messages there between. The session initiation proxy server 227 receives a session signaling message, refers to a routing table 245 for determining a routing address for the message based on an identifier within the message, translates the destination address within the message to the routing address, and forwards the message to the routing address.

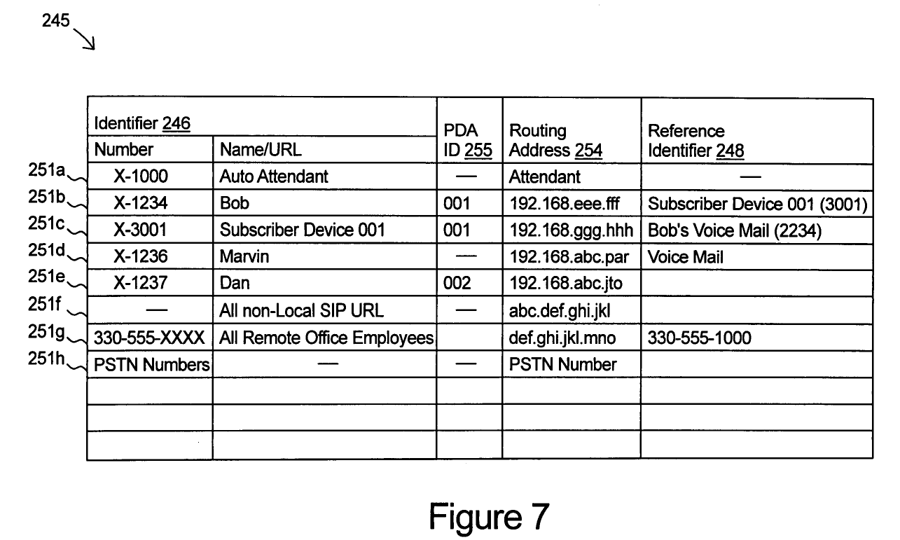

Turning to FIG. 7, an exemplary routing table 245 is shown. The routing table 245 associates a local IP address to each VOIP endpoint (e.g. each station 24 and each wireless telephony device 26) operating on the network 22, associates one or more global IP address to each identifier (or block of identifiers) that may be used to signal a VOIP session to a VOIP endpoint over network 18, and associates the PSTN gateway 131 (or a global IP address of a remote PSTN gateway coupled to network 18) to each identifier (or block of identifiers) that may be used to signal a PSTN session to a circuit switched device over the PSTN 42.

More specifically, the routing table 245 comprises a record 251 for each identifier 246 that may be used to identify the destination of a session signaling message. The identifier 246 may be a number such as a traditional extension number or a traditional local, long distance, or international telephone number that is routable on the PSTN (collectively, a number). The identifier 246 may also be a name, SIP URL, or other identifier of a person (collectively, a name). If a name and number correspond to the same destination, a single record 251 may be used.

Associated with each identifier 246 is: i) a PDA ID code 255 if the identifier is associated with a subscriber to the system 10 and the subscriber has been assigned a PDA 21; ii) a routing address 254; and iii) optionally a reference identifier 248. The routing address 254 represents the address to which the session initiation proxy 227 provides session signaling in response to receiving session signaling with the identifier. The reference identifier 248 is the identifier to which the initiating endpoint is referred if the endpoint associated with the routing address 254 does not respond to the session signaling.

For example, record 251a is associated with the auto attendant server 239. The identifiers that may be used to initiate a session to the auto attendant server 239 include the system “main number” and the name “auto attendant” structured as a SIP URL. When inbound SIP session signaling is received from the PSTN interface 13 (indicating an inbound call over the PSTN 42 on the main number) or when SIP session signaling is received from another VOIP endpoint identifying the “main number” or identifying the “auto attendant”, the session initiation proxy server 227 translates the destination address of the session signaling message and generates session signaling in the form of a SIP invite message to the auto attendant server 239. Because the auto attendant server 239 will always respond the to an Invite message with a SIP 200 OK message, there is no reference identifier in the record 251a (e.g the auto attendant server 239 always answers the telephone). The auto attendant server 239 may transfer a media session to an extension, such functionality will be discussed later herein.

Record 251b is associated with a subscriber, for example, a subscriber named Bob who has been assigned extension number 1234 and who has been assigned a wireless telephony device 26 the ID code 001. When inbound SIP session signaling is received identifying Bob by SIP URL or by extension number, the session initiation proxy server 227 will first initiate session signaling to the routing address 254 which is the current network address of a station 24 that is currently serving Bob. It the station 24 does not respond to the session signaling, the session initiation proxy server 227 will cancel session signaling to the station 24 and refer the initiating VOIP endpoint to the reference identifier 248 which is an identifier that corresponds to Bob's wireless telephony device 26.

Record 251c is assigned to Bob's wireless telephony device 26. When inbound session signaling is received which identifies Bob's device 26 as the destination, the session initiation proxy server 227 will first initiate session signaling to the routing address 254 which is the current network address of Bob's device 26. If Bob's device 26 does not respond to the session signaling, the session initiation proxy server 227 will cancel session signaling to Bob's device 26 and refer the initiating VOIP endpoint to the reference identifier 248 that corresponds to Bob's voice mail box on the voice mail server 236.

Record 251f is associated with all non local SIP URL identifiers. The routing address in record 251f would be the Internet address of a SIP directory and/or proxy service provider coupled to the service provider network 18 that would include table structures similar to table 245 for routing session signaling to one or more other proxy servers and ultimately to a VOIP device associated with the SIP URL identifier.

Record 251g is associated with all telephone numbers that route to (and all SIP URL identifiers of personnel at) a remote office that includes a similar system 10. of the remote office. The routing address 254 corresponds to the IP address of the packet voice/video gateway 232 of the remote office system 10 and the reference identifier 248 may be the main PSTN telephone number of the remote office (for routing on the PSTN) such that media session may route over the PSTN if session signaling over the Internet to the remote system 10 fails.

Record 251h is a record associated with all PSTN telephone numbers that are not included within any of the other records. The routing address is the PSTN number for routing on the PSTN.

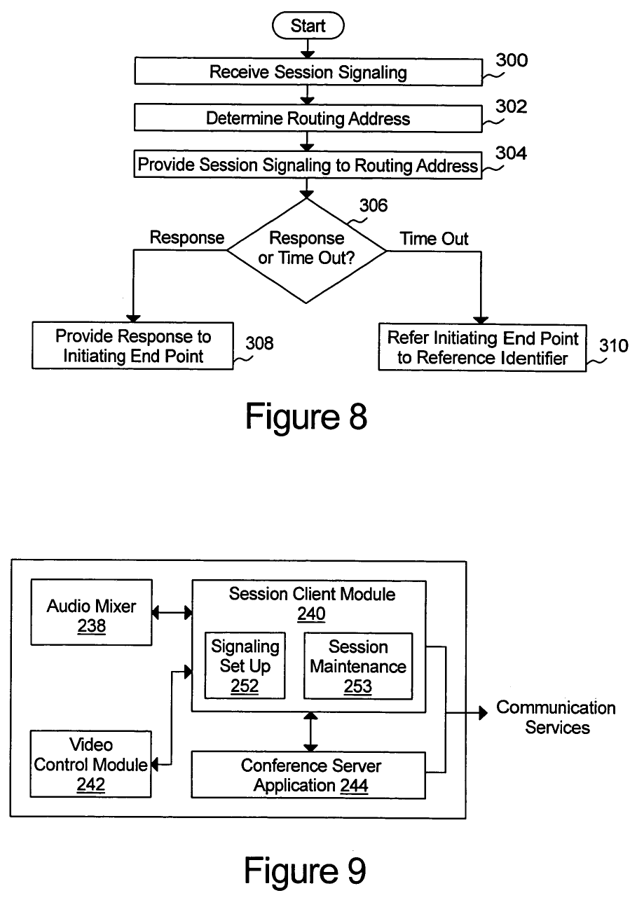

Referring to the flowchart of FIG. 8 in conjunction with FIG. 7, exemplary operation of the session initiation proxy server 227 is shown. Step 300 represents receiving session signaling, such as a SIP Invite message, from an initiating VOIP endpoint that includes an identifier.

Step 302 represents determining the routing address 254 associated with the identifier using the routing table 245 and step 304 represents translating the destination address of the session signaling message to provide session signaling to the destination VOIP endpoint routing address 254.

Step 306 represents determining whether there is a response to the session signaling prior to elapse of a timeout duration. In the exemplary embodiment, a SIP 200 OK message may be considered a response, however, SIP ringing messages may not considered a response.

If the destination endpoint at the routing address responds, step 308 represents translating the destination address in the response message to provide a response to the initiating endpoint such that further session set up messages may be transferred between the initiating endpoint and the destination endpoint.

If the destination endpoint does not respond within the time out period, step 310 represents canceling the session signaling and providing the reference identifier 248 to the initiating endpoint such that the initiating endpoint may provide a session signaling message to the reference identifier.

After a VOIP session is established, communication of audio (and video) data between the two endpoints comprises compressing digital audio data into a sequence of RTP frames, optionally encrypting the RTP frames, and sending the RTP frames to the other endpoint utilizing UDP/IP datagrams on the negotiated channels. At the other endpoint, the UDP/IP datagrams are received, sequenced, and the RTP frames are recovered, decrypted if applicable, and decompressed to yield the digital audio data.

Returning to FIG. 6, to support a VOIP session between a VOIP endpoint on network 22 and a VOIP endpoint on the service provider network 18 or the Internet 30, the translation module 229 includes circuitry for operating as an IP layer proxy for relaying UDP/IP datagrams between the two endpoints.

Confer nce Serv r

A conference session comprises a real time communication session amongst participants such that each participant receives audio representing the other participants. And, each participant with video display capabilities may receive video from other participants that have video capture capability.

Referring to FIG. 9, to provide such conference session capabilities, the conference server 237 comprises a session client module 240, an audio mixer 238, a video control module 242, and a conference server application 244.

The session client module 240 operates as an endpoint to a VOIP session with each conference session participant. More specifically, the session client module establishes a session with each conference participant in accordance with an identification corresponding to each participant as provided by the conference server application 244 and then maintains each VOIP session for the duration of the conference session.

The audio mixer 238 receives an audio stream from the session client module 240 for each conference participant and generates one or more conference mix signals. The conference mix signals are provided to the session client module for transmission to the conference participants.

The video control module 242 receives a video stream from the session client module 240 for each conference participant that provides motion video, generates a motion video stream for each participant in accordance with the participant's video selection (as received from the conference server application 244) and provides each such video stream to the session client module 240 for transmission to the applicable conference participant.

The conference server application 244 controls operation of the audio mixer 238, the session client module 240, and the video control module 242. The conference server application 244 also operates as a web server to provide a user interface to session participants that enable session participants to set up and control a conference session.

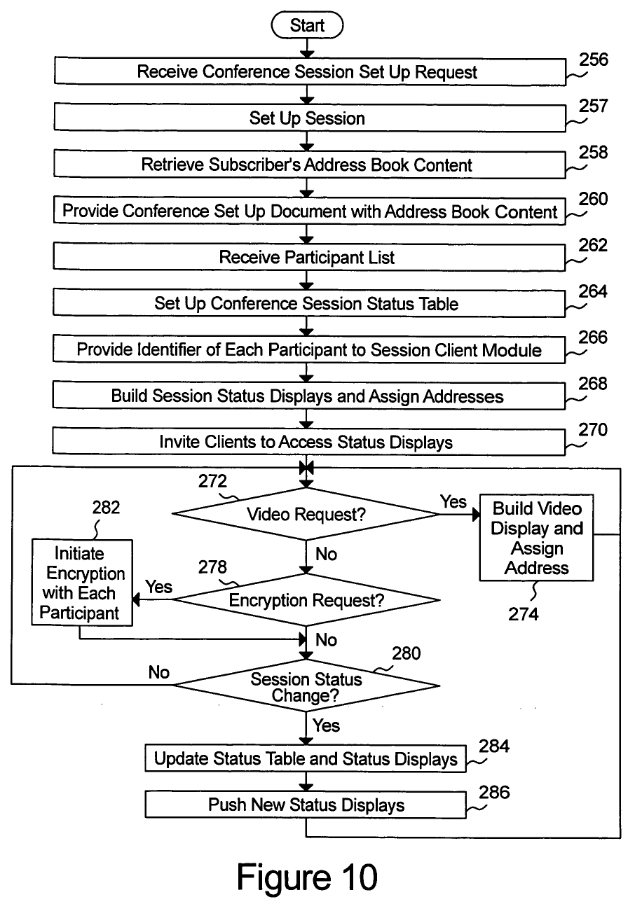

FIG. 10 shows a flowchart that represents exemplary operation of the conference server application 244. Step 256 represents receiving a conference set up request from a subscriber at an initiating subscriber station 24 or a subscriber device 26 (initiating real time communication device 15 of FIG. 1). In the exemplary embodiment, the conference setup request may take the form of the initiating station sending a frame to the conference server application 244, on a predetermined IP address and port number, to establish a TCP/IP connection with the conference server application 244. Step 257 represents establishing the session with the initiating real time communication device 15.

Step 258 represents retrieving the address book content 249 of the subscriber associated with the initiating real time communication device 15 from the email and contact records 247 in storage 235. Step 260 represents providing conference initiation document that includes the address book content 249 to the initiating real time communication device 15 in document format. The document format may be an HTML document, an XML document (e.g. content messages and display layout control messages) or other document format displayable on the initiating real time communication device 15.

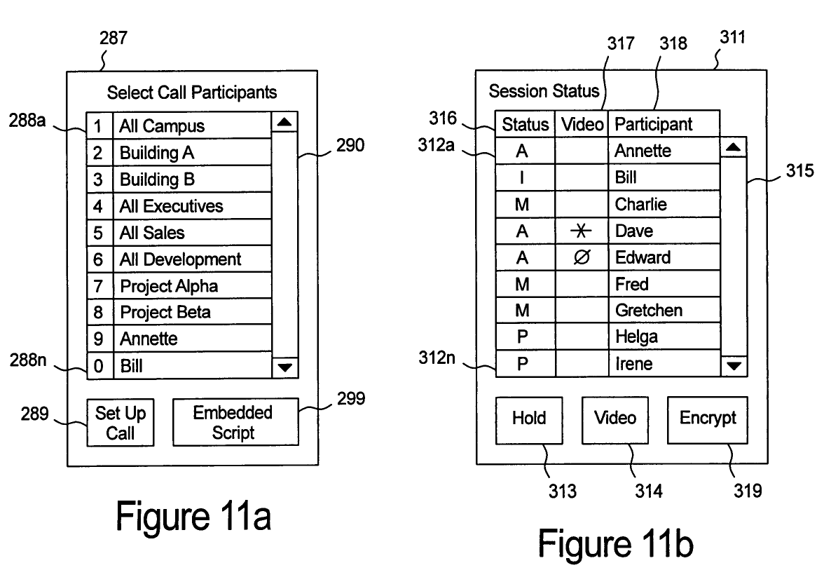

Turning briefly to FIG. 11a, an exemplary conference initiation document 287 is shown. The document 287 includes a record 288 for each contact (or contact group) from the subscriber's address book content and a set up call control 289. A scroll control 290 enables display of additional records 288 that may not fit entirely on the display of the initiating real time communication device 15. The document 287 also includes applicable script to enable the subscriber to highlight multiple records 288 to select multiple conference session participants using the touch panel 59b or the navigation and selection buttons 60b. And, applicable script such that when the subscriber activates the set up call control 289, the selected records 288 are identified to the conference server application 244 over the TCP/IP connection.

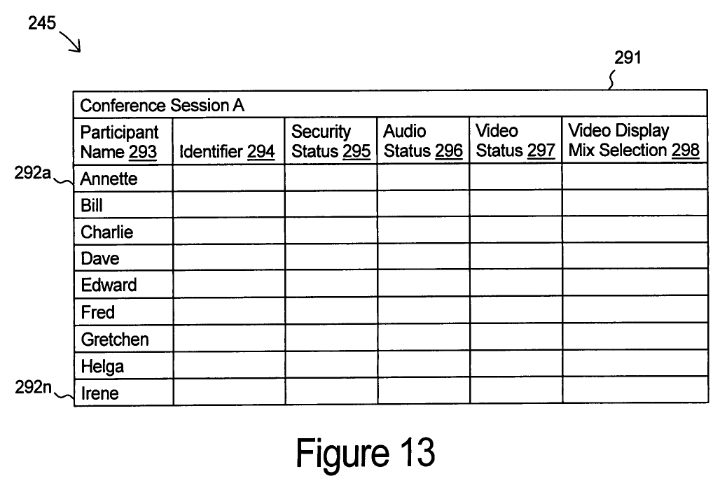

Returning to FIG. 10, step 262 represents receiving the participant list and step 264 represents setting up a session status table for the conference session. Turning to FIG. 13, an exemplary session status table 291 is shown. The session status table 291 includes a record 292 for each conference session participant. Associated with each participant is the participant's name 293 and identifier 294 for setting up a media session to the participant, both from the email and contact records 247. Further associated with each participant is an indication of each of the participant's security status 295, the participant's audio status 296, the participant's video status 297, and the participant's video display mix selection 298, each of which is discussed in more detail herein.

Step 266 represents providing the identifier 294 for each participant from the session status table 291 to the session client module such that the session client module may initiate a media session to each participant.

Step 268 represents building a session status document for each participant. Turning to FIG. 11b, an exemplary session status document 311 is shown. The session status document 311 includes a record 312 for each participant and associated with each participant is an indication of the participant's status. The participants status may be: “A” indicating that the participant is active in the session sending and receiving audio; “I” indicating that the participant is inactive (e.g. no session established with the participant); “M” indicating that the participant is active, receiving an audio stream, but is muted and not sending an audio stream; and “P” indicating that the participant is in a separate and private break-out conference session with one or more other participants.

Step 270 represents inviting each participate to access its status document 311. More specifically, the conference server application 244 may make each participant's status document 311 available on a predetermined port number and may provide a frame to each participant inviting that participant to establish a TCP/IP connection at the particular port number where such participant's status document 311 is available

Steps 272, 278, and 280 together represent the conference server application 244 waiting for a video request event, an encryption request event, and a session status change event.

A video request event corresponds to a subscriber selecting video display parameters and activating the video control 314 on the participant's session status document 311. More specifically, the subscriber may utilize records 312 (and scroll control 315) to highlight multiple (up to four) records associated with participants that are providing video and then activate the video control 314. Scripting in the session status document 311 will provide the video request (that includes identification of the participants associated with the highlighted records) to the conference server application 244 in response to activation of video control 314.

An encryption request event corresponds to a subscriber activating the encryption control 319 on the session status document 311. In response to such activation, script in the session status document 311 will provide the encryption request to the conference server application 244.

A session status change event may be any of a participant entering a session (starting a VOIP session with the session client module 240), departing from a session (terminating a VOIP session with the session client module 240), muting participation in a session (continuing the session but providing nil audio and/or video), beginning or terminating the provision of motion video to the session client module 240, or beginning or terminating of encryption of a session with the session client module 240. Each session status change event may be reported to the conference server application 244 by the session client module 240 and will include an indication of the change event.

In response to a video request event, at step 274 the conference server application 244 will build a video display document and provide the video display document to the participant.

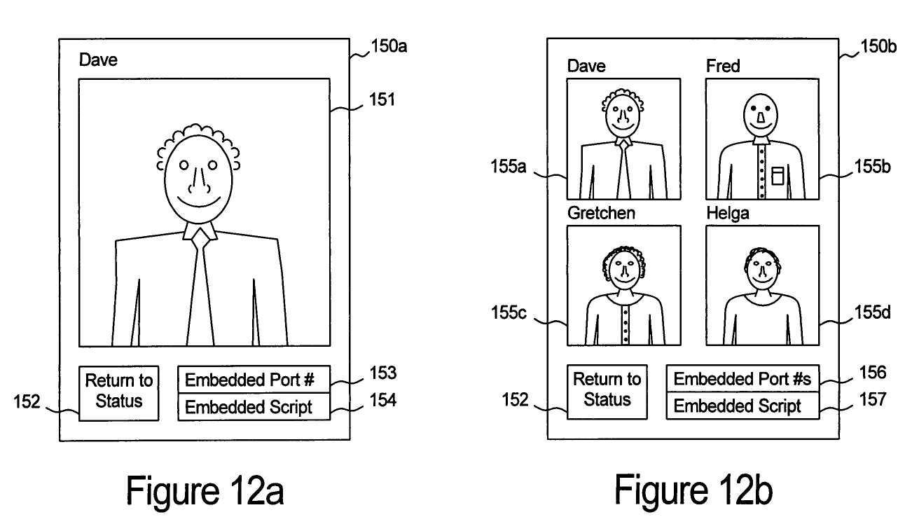

FIG. 12a represents a first video display document 150a that includes a video frame 151, a return to status document control 152, an embedded port number 153 that corresponds to the port number on which the session client module 240 has made the full motion video provided by the participant identified in the video request event available, and embedded scripting 154 that provides for the participant to connect to the port number 153 and display the motion video provided on the port within the frame 151. The return to status document control 152 includes embedded scripting such that upon activation, a request is sent to the conference server application 244 to obtain the session status document 311 as shown in FIG. 11b.

FIG. 12b represents a second video display document 150b that includes four video frames 155a-155d, a return to status document control 152, four embedded port numbers 156 that corresponds to the port numbers on which the session client module 240 has made the full motion video provided by the four participants identified in the video request event available, and embedded script 157 that provides for the participant to connect to each of the port numbers 156 and display the video provided on each port in one of the four frames 155a-155d. The return to status document control 152 includes embedded script such that upon activation, a request is sent to the conference server application 244 to again obtain the session status document 311 as shown in FIG. 11b.

Returning to FIG. 10, in response to an encryption event at step 278, the conference server application 244 will provide a signal to the session client module 240 to initiate encryption with each participant at step 282.

In response to a session status change at step 280, the conference server application 244 will update the status table 291 (FIG. 13) and each status display to correspond to the changed status at step 284 and will provided the updated session status document 311 to each participant.

Web Server

The web server application 230 provides multi media communication services to each subscriber which may include: a) updating of the network location table 245 to assure proper routing of incoming audio and audio/video calls; b) proxy communication over network 18; c) delivery of a multicast messages directed to a subscriber to the particular subscriber station 24 at which his or her subscriber device is then currently coupled; and d) providing a menu control for access to the conference server application 244 and the email module 228.

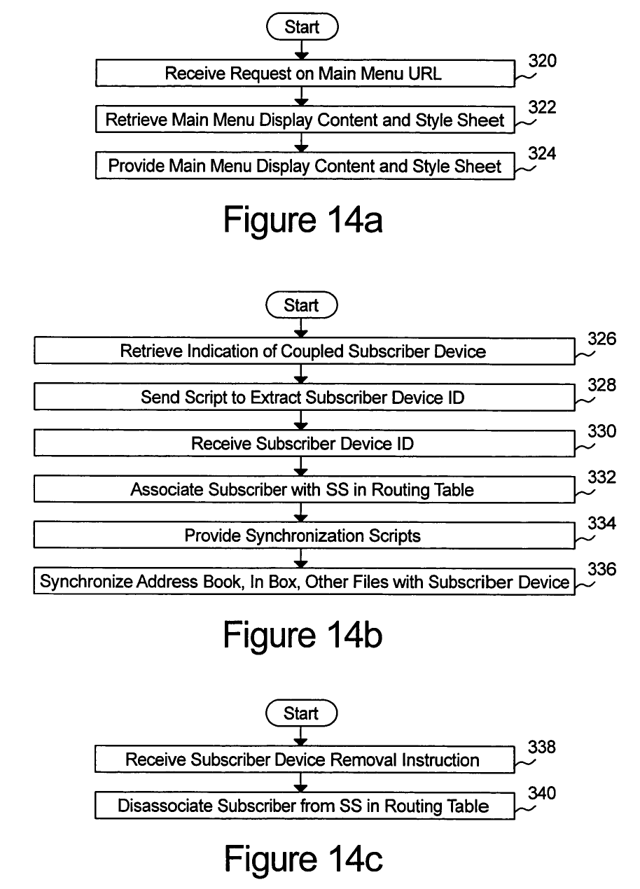

To perform such functions, the web server 230 includes a management application 226 and a multicast application 231. The flowcharts of FIGS. 14a through 14c represent exemplary operation of the management application 226.

Referring to FIG. 14a, step 320 represents the web server 230 receiving an open session request from a telephony station 24 or a wireless telephony device 26 (device 24, 26) that has been operatively coupled to network 22 and is ready to operate as a client of the web server 230. The open session request may take the form of a frame sent by the device 24, 26 to a predetermined port number to open a TCP/IP session with the web server 230.

Step 322 represents retrieving a main menu document from document storage 241. The main menu document may be an HTML document or an XML document or other document format displayable on the device 24, 26. Step 324 represents providing the main menu document to the device 24, 26.

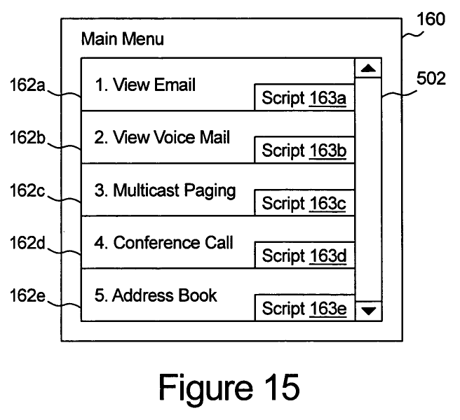

FIG. 15 represents an exemplary main menu document 160. The main menu document 160 includes a plurality of subscriber activated controls 162 that may include an email control 162a, a voice mail control 162b, a multicast paging control 162c, a conference call control 162d, and an address book control 162e.

The email control 162a, the voice mail control 162b, and the address book control 162e each include script 163a, script 163b, and 163e respectively such that when activated, a message is provided to the email module 228 on a predetermined port number indicating such activation. The multicast paging control 162c may include script 163c such that when activated, a message is provided to the multicast application 231 on a predetermined port number indicating such activation. The conference call control 162d may include script 163d such that when activated, a message is provided to the conference server application 244 indicating such activation.

Referring to FIG. 14b, step 326 represents the management application 226 receiving an indication that a PDA 21 has coupled to a station 24 via the point-to-point communication module 62. The indication may take the form of a frame sent by the subscriber station 24 to a predetermined port number.

Step 328 represents the management application 226 providing script to the station 24 that provides for the station 24 to obtain the PDA device ID number associated with the PDA 21 and report the PDA ID number back to the management application 226. Step 330 represents receiving the PDA ID number.

Step 332 represents associating the PDA 21 with the station 24 in the routing table 245 by adding the PDA ID number to the record associated with the station 24.

Step 334 represents providing instructions to the station 24 to activate the subscriber device application 119 on the station 24 to initiate a link with the synchronization application 51 on the PDA 21 and step 336 represents synchronizing email records and contact records 104 in the PDA 21 with the email and contact records 247 in the control unit 12.

Referring to FIG. 14c, step 338 represents the management application 226 receiving an indication that a PDA 21 has de-coupled from a station 24. The indication may take the form of a frame sent by the station 24.

Step 340 represents dissociating the PDA 21 from the station 24 in the routing table 245.

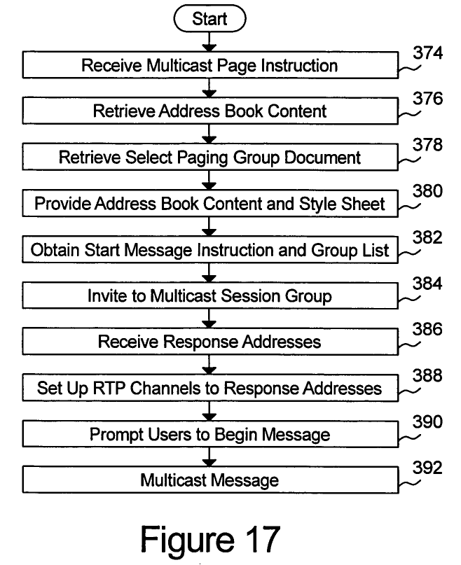

The flowchart of FIG. 17 represents steps performed by the multicast application 231 upon receiving a message indicating subscriber activation of the multicast control 162c. Step 374 represents receipt of such a message.

Step 376 represents retrieving the subscriber's address book content 249 from the email and contact records 247 and step 378 represents retrieving a select paging group document from document storage 241. Step 380 represents providing the select paging group document including the subscriber's address book content 249 to the station 24.

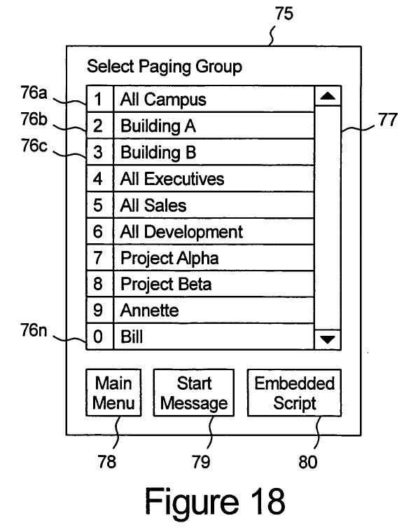

FIG. 18 represents an exemplary select paging group document 75. The document 75 includes a plurality of records 76 (that embody the address book content 249), a scroll control 77, a main menu return control 78, and a start message control 79. Each record 76 is associated with a paging group. Some paging groups may include only a single name such that individuals may be selected to include in the multicast page and some paging groups may include multiple individuals (or multiple sub groups). The document further includes embedded scripting 80 which enables the subscriber to select (using a highlight bar control and the scroll control 77) one or more groups for a multicast paging message. The start message control 79, includes embedded script that provides for identification of the selected paging groups to be provided to the multicast application 231 upon activation.

Returning to FIG. 17, step 382 represents receiving the identification of the selected paging groups. Step 384 represents obtaining a routing address for each selected group participant from the routing table 245 and step 386 represents sending a message to invite each group participant to the multicast session group using the routing address determined for each group participant at step 384. Step 386 represents receiving response messages from the group participants.

Step 388 represents set up of an RTP channels to each response address received from a group participant at step 386.

Step 390 represents prompting the initiating subscriber station 24 to begin the message and step 492 represents providing the message in multicast format on each RTP channel.

Voice Mail

Returning to FIG. 6, the voice mail module 236 includes VOIP client circuits for responding to the call signaling provided by the call signaling module 227, maintaining a VOIP session with an initiating VOIP endpoint, providing a sequence of RTP frames representing applicable audio prompts from compressed audio prompt files 233 to provide a typical voice mail experience to the operator of the initiating endpoint, to receive RTP frames from the initiating VOIP endpoint representing the remote caller leaving a message for the subscriber, and to compress the message into a digital audio file for storage. The voice mail message contained in the digital audio file can be retrieved in a traditional manner by calling into the voice mail server. Alternatively, the voice mail module 226 may send the digital audio file to the email module 228 for storage in the inbox 250 for later retrieval by the subscriber.

E-Mail

The email module 228 maintains an email account associated with each subscriber. The email module 228 includes client circuits for interfacing with a remote email server for receiving email messages for each subscriber and for storing in the subscriber inbox, and sends email messages drafted by the subscriber. The email module 228 also maintains the email files 247 in the storage 235 that may include the address book content 249 and the inbox 250 for each subscriber.

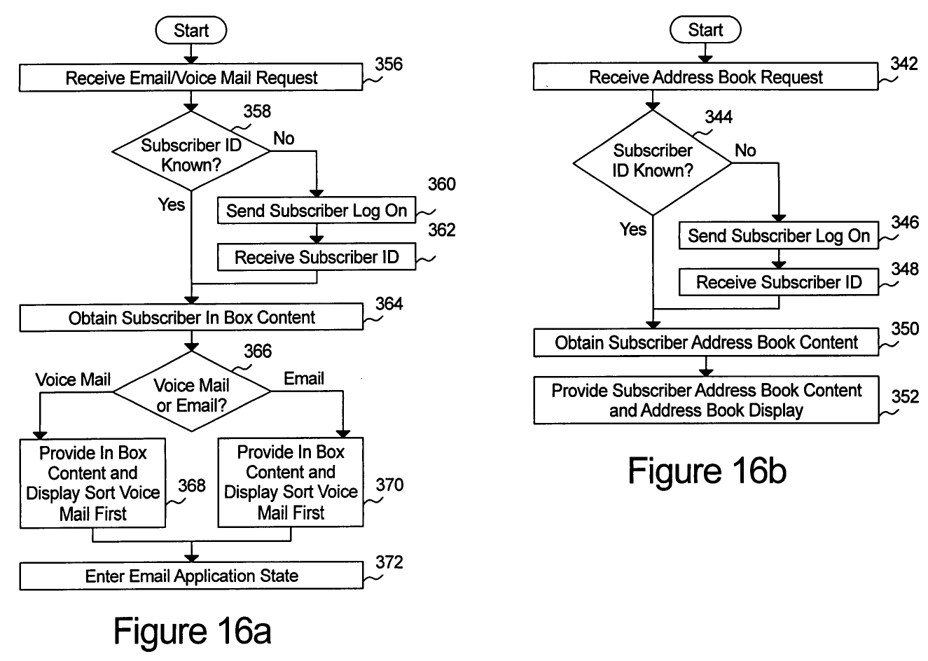

The email module 228 may be any commercially available email server that supports inbox and address book functionality and provides client services through a web document interface. Because the main menu document 160 includes separate controls for voice mail, email, and address book, the flow charts of FIGS. 16a and 16b represents exemplary operation of the email module 228 upon receipt of a message indicating one of such controls from the main menu document 160.

The flowchart of FIG. 16a represents steps performed by the email module 228 upon subscriber activation of the email control 162a or the voice mail control 162b. Step 356 represents receipt of a message indicating such activation from a subscriber station 24.

Step 358 represents a determination whether the identity of the subscriber at the subscriber station 24 is recorded in the routing table 245. If a PDA 21 is associated with the station 24 or if a subscriber is associated with the station 24 in the routing table 245, the system proceeds directly to step 364 wherein inbox content 250 associated with the subscriber is retrieved from the email and contact records 247. However, if a subscriber is not associated with the station 24 in the routing table 245, the system proceeds to step 260 wherein a logon screen is provided to the station 24 and a subscriber identifier is received from the station 24 at step 362. Then the system proceeds to step 364.

Step 366 represents a determination whether the subscriber activated the email control 162a or the voice mail control 162b. If the subscriber activated the email control 162a, the inbox content 250 is sorted such that email messages (messages other than those with voice mail attachments received from the voice mail server 236) are displayed at the top of the list at step 370. Alternatively, if the subscriber activated the voice mail control 162b, the inbox content is sorted such that the email messages that include voice mail attachments are displayed at the top of the list at step 368.

Step 372 represents retrieving a messaging document template from document storage 241 and providing a messaging document with the sorted inbox content 250 embedded with the messaging document template to the station 24.

The flowchart of FIG. 16b represents exemplary steps performed by the email module 228 upon receipt of a message, at step 342, indicating subscriber activation of the address book control 162e.

Step 344 represents a determination whether the identity of the subscriber at the subscriber station 24 is recorded in the routing table 245. If a PDA 21 is associated with the station 24 or if a subscriber is associated with the station 24 in the routing table 245, the system proceed directly to step 350 wherein address book content 249 associated with the subscriber is retrieved from the email and contact records 247. However, if a subscriber is not associated with the station 24 in the routing table 245, the system proceeds to step 346 wherein a logon screen is provided to the station 24 and a subscriber identifier is received from the station 24 at step 348. Then the system proceeds to step 350.

Step 352 represents retrieving an address book document template from document storage 241 and providing the address book content 249 embedded in the address book document template to the station 24.

Conclusion

It should be appreciated that the systems and methods of the present invention provides an enhanced interface for conference call services. Although the invention has been shown and described with respect to certain preferred embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of the modular multi-media communication management system of the present invention. The present invention includes all such equivalents and modifications, and is limited only by the scope of the following claims.

What is claimed:

1. A communication control unit for facilitating a communication conference between a plurality of real time communication devices, the control unit comprising:
a local network interface for exchanging local network data over a packet switched network with each of the plurality of real time communication devices;
means for receiving an identification of each of a plurality of real time communication devices selected as conference participants;
means for establishing a plurality of real time audio conference channels, each channel between the control unit and a conference participant, each channel for receiving streaming audio data from the conference participant and for providing conference mix streaming audio to each participant;
means for generating at least one conference mix signal comprising a mix of the streaming audio data from at least two participants.

2. The communication control unit of claim 1, wherein the means for establishing a real time audio channel with each of the conference participants comprises means for providing session signaling to each session participant and means for negotiating the set up of a real time audio channel with a conference participant in response to the conference participant responding to the session signaling.

3. The communication control unit of claim 1, further comprising:
an address book file storing address book content, the address book content comprising an identification of each of a plurality of contacts;
means for providing the address book content to one of the real time communication devices in response to the real time communication device providing an indication of a request to establish a communication conference; and
the means for receiving an identification of each of a plurality of real time communication devices selected as conference participants comprises means for receiving an indication of subscriber selection of contacts from the address book content.

4. The communication control unit of claim 3, wherein the means for providing the address book content to one of the real time communication devices comprises means for providing a conference initiation document for display on the real time communication device, the conference initiation document comprising the address book content in association with a display template adapted for operator selection of contacts form the address book content.

5. The communication control unit of claim 4, wherein the conference initiation document comprises means for subscriber selection of contacts, a conference initiation control, and means for providing identification of the selected contacts to the control unit in response to subscriber activation of the conference initiation control.

6. The communication control unit of claim 5, wherein:
the means for establishing a real time communication channel with each of the plurality of conference participants further provides for receiving motion video data from at least one conference participant and providing motion video data to at least a second conference participant; and
further comprising means for providing a video display document to the second conference participant for display on the second conference participant, the video display document comprising a frame for display of the motion video data.

7. The communication control unit of claim 1, further comprising:
means for providing a main menu document for display on one real time communication device, the main menu document comprising a control for subscriber selection of at least one messaging service, a control for selection of initiating a communication conference, and means for providing a request to establish a conference session to the control unit in response to subscriber activation of the control for selection of initiating a communication conference.

8. The communication control unit of claim 7, further comprising:
an address book file storing address book content, the address book content comprising an identification of each of a plurality of contacts;
means for providing the address book content to one of the real time communication device in response to receipt of the request to establish a communication conference;
the means for receiving an identification of each of a plurality of real time communication devices selected as conference participants comprises means for receiving an indication of subscriber selection of contacts from the address book content.

9. The communication control unit of claim 8, wherein the means for providing the address book content to one of the real time communication devices comprises means for providing a conference initiation document for display on the real time communication device, the conference initiation document comprising the address book content in association with a display template adapted for operator selection of conference session participants.

10. The communication control unit of claim 9, wherein the conference initiation document comprises means for subscriber selection of contacts, a conference initiation control, and means for providing identification of the selected contacts to the control unit in response to subscriber activation of the conference initiation control.

11. The communication control unit of claim 10, wherein:
the means for establishing a real time communication channel with each of the plurality of conference participants further provides for receiving motion video data from at least one conference participant and providing motion video data to at least a second conference participant; and
further comprising means for providing a video display document to the second conference participant for display on the second conference participant, the video display document comprising a frame for display of the motion video data.

12. A method for facilitating a communication conference between a plurality of real time communication devices, the method operating in a control unit and comprising:
communicating with each of a the real time communication devices over a packet switched network interconnecting the control unit and each of the real time communication devices;
receiving an identification of each of a plurality of real time communication devices selected as conference participants;
establishing a plurality of real time audio conference channels, each channel between the control unit and a conference participants, each real time audio conference channel for receiving streaming audio data from the conference participant and for providing a conference mix streaming audio data to the participant;
generating conference mix streaming audio data from streaming audio data received from at least two participants.

13. The method of claim 12, wherein the step of establishing a plurality of real time audio channels comprises:
providing session signaling to each session participant; and
negotiating set up of a real time audio channel with a conference participant in response to the conference participant responding to the session signaling.

14. The method of claim 12, further comprising:
obtaining address book content from an address book file, the address book content comprising an identification of each of a plurality of contacts;
providing the address book content to one of the real time communication devices in response to the real time communication device providing an indication of a request to establish a communication conference; and
the step of receiving an identification of each of a plurality of real time communication devices selected as conference participants comprises receiving an indication of subscriber selection of contacts from the address book content.

15. The method of claim 14, wherein the step of providing the address book content to one of the real time communication devices comprises providing a conference initiation document for display on the real time communication device, the conference initiation document comprising the address book content in association with a display template adapted for operator selection of contacts form the address book content.

16. The method of claim 15, wherein the step of providing a conference initiation document comprises providing script providing for:
subscriber selection of contacts,
a conference initiation control, and
identification of the selected contacts to the control unit in response to subscriber activation of the conference initiation control.

17. The method of claim 16, wherein:
the step of establishing a plurality of real time audio conference channels further comprises:
establishing a real time communication channel with at least one conference participant for receiving motion video data from the at least one conference participant and providing motion video data to at least a second conference participant; and
establishing a real time communication channel with at least on other conference participant for providing a representation of the motion video data to the at least one other conference participant.

18. The method of claim 12, further comprising:
providing a main menu document for display on one real time communication device, the main menu document comprising a control for subscriber selection of at least one messaging service, a control for selection of initiating a communication conference, and means for providing a request to establish a conference session to the control unit in response to subscriber activation of the control for selection of initiating a communication conference.

19. The method of claim 18, further comprising:
obtaining address book content from an address book file, the address book content comprising an identification of each of a plurality of contacts;
providing the address book content to the request to establish a conference session; and
the step of receiving an identification of each of a plurality of real time communication devices selected as conference participants comprises receiving an indication of subscriber selection of contacts from the address book content.
an address book file storing address book content, the address book content comprising an identification of each of a plurality of contacts;

20. The method of claim 19, wherein the wherein the step of providing the address book content to one of the real time communication devices comprises providing a conference initiation document for display on the real time communication device, the conference initiation document comprising the address book content in association with a display template adapted for operator selection of contacts form the address book content.

21. The method of claim 20, wherein the step of providing a conference initiation document comprises providing script providing for:
subscriber selection of contacts,
a conference initiation control, and
identification of the selected contacts to the control unit in response to subscriber activation of the conference initiation control.

22. The method of claim 21, wherein:
the step of establishing a plurality of real time audio conference channels further comprises:
establishing a real time communication channel with at least one conference participant for receiving motion video data from the at least one conference participant and providing motion video data to at least a second conference participant; and
establishing a real time communication channel with at least on other conference participant for providing a representation of the motion video data to the at least one other conference participant.
